(19) United States
(12) Patent Application Publication
(10) Pub. No.: US 2025/0281865 A1
(43) Pub. Date: Sep. 11, 2025

(54) AIR CLEANER

(71) Applicant: LG ELECTRONICS INC., Seoul (KR)

(72) Inventors: Sejin CHOI, Seoul (KR); Hojung KIM, Seoul (KR); Changkyum KIM, Seoul (KR); Chiyoung CHOI, Seoul (KR)

(73) Assignee: LG ELECTRONICS INC., Seoul (KR)

(21) Appl. No.: 19/073,794

(22) Filed: Mar. 7, 2025

(30) Foreign Application Priority Data
Mar. 8, 2024 (KR) 10-2024-0033181

(51) Int. Cl. B01D 46/00; B01D 46/24; B01D 46/42; B01D 46/58

(52) U.S. Cl. CPC B01D 46/0049; B01D 46/0002; B01D 46/2403; B01D 46/4245; B01D 46/58; B01D 2273/30

(57) ABSTRACT

Disclosed is an air cleaner capable of preventing an air return phenomenon. The air cleaner includes a case including a suction port disposed on a peripheral surface of the case, a first air cleaning module disposed in the case, the first air cleaning module including a first blower fan, a first filter configured to remove foreign matter from air introduced through the suction port, and a first discharge port disposed at a bottom of the first air cleaning module, the first discharge port being configured to discharge air filtered by the first filter in a downward direction, and a second air cleaning module disposed in the case, the second air cleaning module including a second blower fan, a second filter configured to remove foreign matter from air introduced through the suction port, and a second discharge port disposed at a top of the second air cleaning module.

### CROSS-REFERENCE TO RELATED APPLICATION

This application claims the priority benefit of Korean Patent Application No. 10-2024-0033181, filed on Mar. 8, 2024 in the Korean Intellectual Property Office, the disclosure of which is incorporated herein by reference.

### BACKGROUND OF THE INVENTION

### 1. Field of the Invention

The present disclosure relates to an air cleaner, and more particularly to an air cleaner capable of discharging purified air in various directions.

### 2. Description of the Related Art

An air cleaner is a device that filters air in a certain space and discharges the filtered air, thereby reducing the concentration of dust or bacteria in the air in the corresponding space. The air cleaner filters out foreign matter by generating a flow of air in the corresponding space, and discharges air with the foreign matter removed therefrom.

In order to quickly purify air in the indoor space, a discharge port may be formed in an upper portion of an air cleaner, and filtered air discharged upwardly may be guided so as to flow in all directions.

Further, in the case in which a discharge port is formed in an upper portion of an air cleaner, a separate fan for regulation of the direction of air discharged may be disposed at an upper portion of the air cleaner in order to cause filtered air to flow a long distance.

Research on a multistage air cleaner in which blowing devices are stacked vertically is underway.

Related Art Document 1 (Korean Patent Laid-Open Publication No. 10-2022-0083719) and Related Art Document 2 (Korean Patent Laid-Open Publication No. 10-2017-0140578) disclose air cleaners, in each of which blowing devices are disposed in a vertical direction to filter a large amount of air.

Such an air cleaner of the related art has an advantage of increasing blowing capacity and suctioning and discharging air in a wider variety of directions, thereby easily purifying the surrounding air regardless of whether a user in the room is sitting or standing.

However, in the air cleaner of the related art, air discharged from the lower blowing device is strongly blown upwardly, thus causing an air return phenomenon. That is, purified air discharged from the lower blowing device may be introduced into the upper blowing device.

Further, if the e amount of air flowing upward is excessively large, the purified air may not circulate over a long distance.

Further, if the air returning phenomenon occurs, the air flowing back into the upper blowing device acts as an obstacle that impedes introduction of impure outside air into the upper blowing device, thus reducing the flow amount of air in the upper blowing device.

In order to solve the above-described problems, each of the air cleaners of the related art disclosed in Related Art Document 1 (Korean Patent Laid-Open Publication No. 10-2022-0083719) and Related Art Document 2 (Korean Patent Laid-Open Publication No. 10-2017-0140578) includes a partition plate disposed between the plurality of blowing devices in order to change the flow direction of air, thereby preventing the air return phenomenon.

However, because the flow amount of air that collides with the partition wall and flows in the lateral direction is smaller than the flow amount of air rising in the radially outward direction, it is not possible to sufficiently change the flow direction of the rising air discharged from the lower blowing device, and thus the discharged air may rise in the substantially oblique direction and may flow back into the upper blowing device.

If the height at which the partition plate is located is lowered in order to increase the flow amount of air that collides with the partition wall and flows in the lateral direction, an air discharge area may be reduced.

If the air cleaner employs an airflow guide structure for preventing the air return phenomenon, such as a partition plate, the overall height and size of the product may increase, and the exterior of the product may appear discontinuous.

Further, in the air cleaners disclosed in the above related art documents, the peripheral grille is divided into an upper part and a lower part, which causes increase in the number of fastening portions and inconvenience in management and cleaning of components. Furthermore, in the air cleaners disclosed in the above related art documents, because the suction port is blocked by the pillar of the filter mounting part, flow resistance may occur, and thus air cleaning performance may be reduced.

### SUMMARY OF THE INVENTION

An aspect of the present disclosure is directed to providing an air cleaner capable of preventing discharged purified air from flowing back thereinto, thereby improving air cleaning performance.

Another aspect of the present disclosure is directed to providing an air cleaner capable of preventing an air return phenomenon without adding a structure such as a partition plate, thereby having a reduced size.

Still another aspect of the present disclosure is directed to providing an air cleaner capable of forming an airflow that effectively removes allergens causing allergies. Still another aspect of the present disclosure is directed to providing an air cleaner capable of improving suction capacity of air suctioned into the air cleaner.

Still another aspect of the present disclosure is directed to providing an air cleaner capable of facilitating coupling and separation of a case forming the external appearance of the air cleaner.

Still another aspect of the present disclosure is directed to providing an air cleaner capable of simplifying a case coupling structure and reducing manufacturing costs.

Still another aspect of the present disclosure is directed to providing an air cleaner enabling convenient replacement of a filter.

Still another aspect of the present disclosure is directed to providing an air cleaner capable of facilitating maintenance and repair of internal parts.

Still another aspect of the present disclosure is directed to providing an air cleaner capable of causing discharged purified air to circulate over a longer distance.

The aspects of the present disclosure are not limited to the aspects mentioned above, and other aspects not mentioned herein will be clearly understood by those skilled in the art from the following description.

An air cleaner according to an embodiment of the present disclosure discharges purified air through the bottom of the product, thereby preventing the discharged air from being introduced thereinto through a suction port formed in an upper side of the product.

An air cleaner according to an embodiment of the present disclosure is configured such that an air cleaning module configured to discharge purified air through the top thereof and an air cleaning module configured to discharge purified air through the bottom thereof are stacked vertically, thereby preventing an air return phenomenon and improving an air cleaning performance.

An air cleaner according to an embodiment of the present disclosure does not require a structure for preventing the air return phenomenon, thereby having a reduced size and improving freedom of design, such as placement of internal parts.

An air cleaner according to an embodiment of the present disclosure is configured to form an airflow at a height at which allergens causing allergies are mainly located, thereby effectively removing the allergens.

An air cleaner according to an embodiment of the present disclosure suctions air through a suction port formed in the peripheral surface of a case, thereby improving suction performance.

An air cleaner according to an embodiment of the present disclosure exhibits improved performance of suctioning air into a filter while securing sufficient support rigidity through a truss structure.

An air cleaner according to an embodiment of the present disclosure is configured such that a single case covers the outer circumferential surfaces of all of air cleaning modules stacked vertically, rather than being divided into a plurality of parts for covering the respective air cleaning modules, thereby facilitating coupling and separation of the case and reducing manufacturing costs.

An air cleaner according to an embodiment of the present disclosure includes a case having a suction port formed in the peripheral surface thereof and an air cleaning module including a blower fan disposed in the case and a filter configured to remove foreign matter from air introduced through the suction port, the air cleaning module includes a first discharge port formed in the bottom thereof and a second discharge port formed in the top thereof, and air with foreign matter removed therefrom is discharged downwardly through the first discharge port and is discharged upwardly through the second discharge port, thereby preventing an air return phenomenon.

The air cleaning module includes a first air cleaning module and a second air cleaning module disposed above the first air cleaning module.

The first discharge port is formed in the bottom of the first air cleaning module, and the second discharge port is formed in the top of the second air cleaning module.

The air cleaner may further include a booster module disposed above the air cleaning module to regulate the direction of air discharged through the second discharge port, thereby sending purified air farther away.

The air cleaner may further include a bottom plate disposed below the air cleaning module so as to be in contact with the floor.

An airflow guide may be disposed on an upper surface of the bottom plate so as to guide air discharged downwardly through the first discharge port in a lateral direction.

The airflow guide may include a curved portion, a flat portion extending laterally from the curved portion, and a boss protruding upward from an end portion of the flat portion.

A lower discharge grille including a plurality of grilles bent in an outward direction may be disposed inside the first discharge port.

The booster module may include an outer cover, an inner grille disposed inside the outer cover and having a discharge port formed therein, a rear suction grille having a suction port formed therein, a booster fan disposed on a front surface of the rear suction grille and disposed inside the inner grille, and a motor configured to rotate the booster fan.

The booster module may further include a display panel disposed on a front surface of the booster fan and an inner flow guide disposed between the outer cover and the inner grille to change the flow direction of air discharged through the discharge port of the inner grille.

The air discharged through the discharge port of the inner grille may pass through a slit formed between the inner flow guide and the display panel.

The display panel may cover the entirety of the front surface of the booster fan.

The motor may be disposed inside the booster fan.

The booster module may be removably mounted to the top of the second air cleaning module.

The booster module may further include a power module configured to come into contact with a terminal of the second air cleaning module and receive power from the second air cleaning module when the booster module is mounted to the second air cleaning module.

The case may include a first case having a semi-cylindrical shape and covering a portion of the outer circumferential surface of the air cleaning module and a second case having a semi-cylindrical shape and covering the remaining portion of the outer circumferential surface of the air cleaning module.

The air cleaning module may include a first magnet and a second magnet disposed above the first magnet.

The first case may include a first lower metallic piece coupled to the first magnet and a first upper metallic piece coupled to the second magnet.

The second case may include a second lower metallic piece coupled to the first magnet and a second upper metallic piece coupled to the second magnet.

The air cleaning module may include a fan housing accommodating the blower fan and a plurality of support parts extending vertically from the fan housing.

Some of the plurality of support parts may be formed in a truss structure in which a plurality of linear members is arranged in a plurality of triangular forms.

The details of other embodiments will be included in the detailed description and the drawings below.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 is a perspective view of an air cleaner according to an embodiment of the present disclosure;

FIG. 2 is a cross-sectional view of the air cleaner according to the embodiment of the present disclosure;

FIG. 3 is a view showing an airflow generated by the air cleaner according to the embodiment of the present disclosure;

FIG. 4 is an exploded view of the air cleaner according to the embodiment of the present disclosure;

FIG. 5 is an assembled view of a booster module according to the embodiment of the present disclosure;

FIGS. 6 and 7 are exploded views of the booster module according to the embodiment of the present disclosure;

FIG. 8 is a cross-sectional view of the booster module according to the embodiment of the present disclosure;

FIG. 9 is a view showing an airflow in the booster module according to the embodiment of the present disclosure;

FIG. 10 is an assembled view of a first air cleaning module according to the embodiment of the present disclosure;

FIGS. 11 and 12 are exploded views of the first air cleaning module according to the embodiment of the present disclosure;

FIG. 13 is an assembled view of a control module according to the embodiment of the present disclosure;

FIGS. 14 and 15 are exploded views of the control module according to the embodiment of the present disclosure;

FIG. 16 is an assembled view of a second air cleaning module according to the embodiment of the present disclosure;

FIGS. 17 and 18 are exploded views of the second air cleaning module according to the embodiment of the present disclosure;

FIGS. 19 to 21 are views for explaining discharge of purified air through the bottom of the air cleaner according to the embodiment of the present disclosure;

FIGS. 22A to 22E are views for explaining performance comparison between a case in which purified air is discharged through the upper and lower ends of the product and a case in which purified air is discharged only through the upper end of the product;

FIGS. 23 and 24 are views for explaining a case coupling structure according to the embodiment of the present disclosure; and

FIGS. 25 to 28 are views for explaining the structure of support parts according to the embodiment of the present disclosure.

### DETAILED DESCRIPTION OF THE PREFERRED EMBODIMENTS

Hereinafter, exemplary embodiments of the present disclosure will be described in detail with reference to the accompanying drawings. The present disclosure may, however, be embodied in many different forms, and should not be construed as being limited to the embodiments set forth herein.

In the drawings, illustration of parts unrelated to the description is omitted to clearly and briefly describe the present disclosure, and the same or extremely similar components are denoted by the same reference numerals throughout the specification.

As used herein, the terms with which the names of components are suffixed, “module” and “unit”, are assigned to facilitate preparation of this specification, and are not intended to suggest unique meanings or functions. Accordingly, the terms “module” and “unit” may be used interchangeably.

It will be understood that although the terms “first”, “second”, etc., may be used herein to describe various components, these components should not be limited by these terms. These terms are only used to distinguish one component from another component.

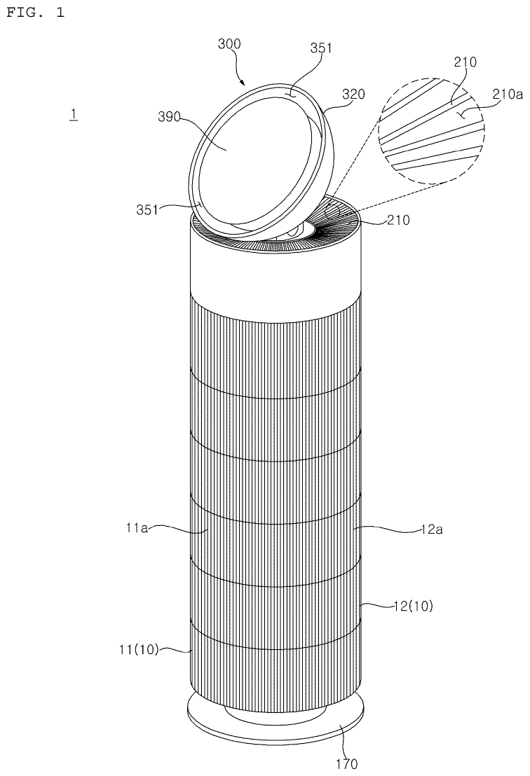

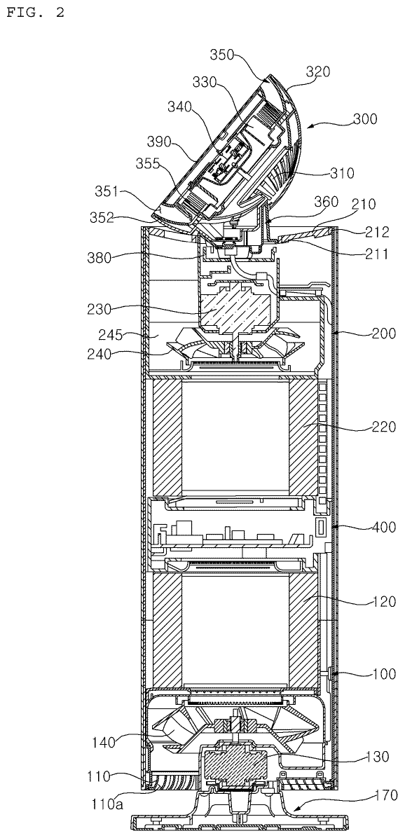

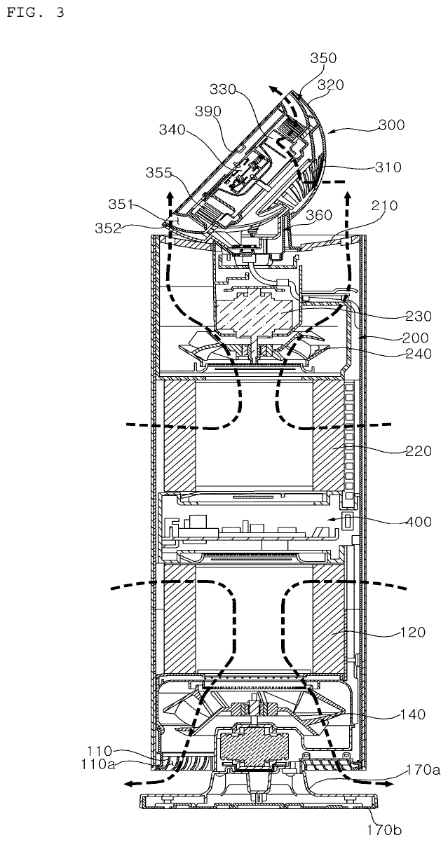

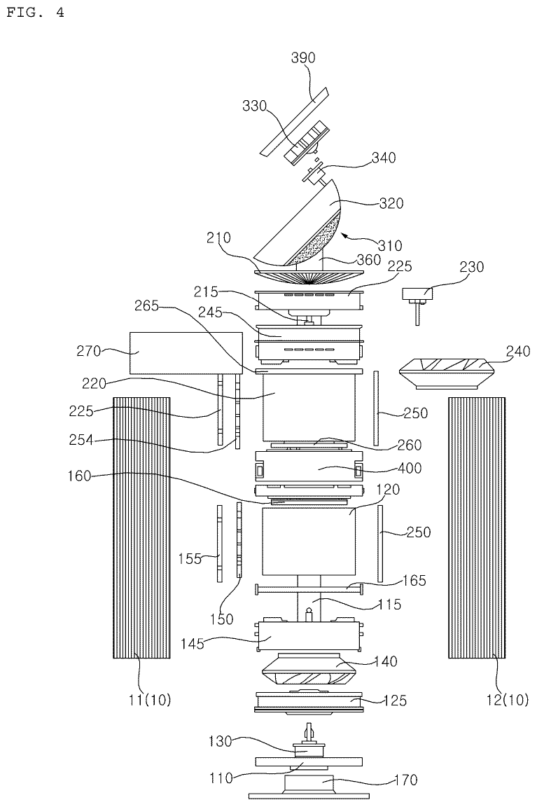

FIG. 1 is a perspective view of an air cleaner according to an embodiment of the present disclosure. FIG. 2 is a cross-sectional view of the air cleaner according to the embodiment of the present disclosure, and FIG. 3 is a view showing an airflow generated by the air cleaner according to the embodiment of the present disclosure. FIG. 4 is an exploded view of the air cleaner according to the embodiment of the present disclosure.

Referring to FIGS. 1 to 4, the air cleaner 1 includes a case 10 forming the external appearance thereof. The case 10 may have suction ports 11a and 12a formed in the peripheral surface thereof to suction air from various directions. Air may be suctioned from all directions with respect to a central line passing through the internal center of the case 10 in an upward-downward direction. The suction ports 11a and 12a are provided in plural, and the plurality of suction ports 11a and 12a is spaced apart from each other in the circumferential direction of the case 10. The plurality of suction ports 11a and 12a is evenly formed in the circumferential direction along the peripheral surface of the case 10 so that air is capable of being suctioned into the case 10 from any direction.

In this specification, the upward-downward direction or the vertical direction is defined as an axial direction. The axial direction may correspond to the central axis-direction of blower fans 140 and 240, which will be described later, i.e., the motor shaft direction of the fans. The radial direction or the horizontal direction may be understood as a direction perpendicular to the axial direction. The circumferential direction may be understood as a circumferential direction of an imaginary circle that is formed when rotating about the axial direction with a distance in the radial direction as a rotational radius.

The air cleaner 1 includes air cleaning modules 100 and 200 that generate airflows. The air cleaning modules 100 and 200 include blower fans 140 and 240, which are disposed in the case 10, and filters 120 and 220, which remove foreign matter from air introduced through the suction ports 11a and 12a, respectively.

The air introduced through the suction ports 11a and 12a may pass through the filters 120 and 220. Each of the filters 120 and 220 may be formed in a cylindrical shape and may have a filter surface that filters air.

The case 10 may have a cylindrical shape. The case 10 may include a first case 11, which has a semi-cylindrical shape and covers portions of the outer circumferential surfaces of the air cleaning modules 100 and 200, and a second case 12, which has a semi-cylindrical shape and covers the remaining portions of the outer circumferential surfaces of the air cleaning modules 100 and 200.

Alternatively, the case 10 may have a shape of a truncated cone (a cone with the top cut off), and each of the first case 11 and the second case 12 may have a shape of a semi-truncated cone.

The first case 11 and the second case 12 may be coupled to each other to form the external appearance of the air cleaner 1. Because the first case 11 covers the front surface of the air cleaner 1, the first case 11 may be referred to as a “front case” or a “front cover”. Because the second case 12 covers the rear surface of the air cleaner 1, the second case 12 may be referred to as a “rear case” or a “rear cover”.

The suction ports 11a and 12a include a first suction port 11a formed in the first case 11 and a second suction port 12a formed in the second case 12. The suction ports 11a and 12a allow the inside of the case 10 and the outside to communicate with each other. The suction ports 11a and 12a are provided in plural. The plurality of suction ports 11a and 12a may be formed in the peripheral surface of the case 10.

The plurality of suction ports 11a and 12a is evenly formed in the circumferential direction along the outer circumferential surface of the case 10 so that air is capable of being suctioned into the case 10 from any direction.

The plurality of suction ports 11a and 12a is formed in a stripe shape that is elongated in the upward-downward direction. Alternatively, the plurality of suction ports 11a and 12a may be formed through perforation in a circular or elliptical shape.

As described above, because the case 10 is formed in a cylindrical shape and the plurality of suction ports 11a and 12a is formed along the outer circumferential surface of the case 10, the amount of air suctioned may increase.

Referring to FIGS. 1 to 4, the air cleaning modules 100 and 200 include a first air cleaning module 100 and a second air cleaning module 200 that are disposed in the upward-downward direction.

For example, the second air cleaning module 200 may be disposed above the first air cleaning module 100. Because the first air cleaning module 100 is disposed at a lower portion of the air cleaner 1, the first air cleaning module 100 may be referred to as a “lower air cleaning module” or a “lower module”, and because the second air cleaning module 200 is disposed at an upper portion of the air cleaner 1, the second air cleaning module 200 may be referred to as an “upper air cleaning module” or an “upper module”.

The first air cleaning module 100 and the second air cleaning module 200 include blower fans 140 and 240 and filters 120 and 220 configured to remove foreign matter from air introduced through the suction ports 11a and 12a, respectively.

The first air cleaning module 100 includes a first blower fan 140 and a first filter 120 configured to remove foreign matter from air introduced through the suction ports. In addition, the first air cleaning module 100 further includes a first fan motor 130 configured to rotate the first blower fan 140.

The second air cleaning module 200 includes a second blower fan 240 and a second filter 220 configured to remove foreign matter from air introduced through the suction ports. In addition, the second air cleaning module 200 further includes a second fan motor 230 configured to rotate the second blower fan 240.

The air cleaning modules 100 and 200 include a first discharge port 110a formed in the bottom of the air cleaning module 100 and a second discharge port 210a formed in the top of the air cleaning module 200. The first discharge port 110a is formed below the first blower fan 140 and the first filter 120. The second discharge port 210a is formed above the second blower fan 240 and the second filter 220. Air with foreign matter removed therefrom by the filters 120 and 220 is discharged downwardly through the first discharge port 110a and is discharged upwardly through the second discharge port 210a.

In the case in which the second air cleaning module 200 is disposed above the first air cleaning module 100, the first discharge port 110a is formed in the bottom of the first air cleaning module 100, and the second discharge port 210a is formed in the top of the second air cleaning module 200.

In addition, a lower discharge grille 110 including a plurality of grilles is disposed at the bottom of the first air cleaning module 100 in order to guide a lower airflow. In addition, an upper discharge grille 210 including a plurality of grilles is disposed at the top of the second air cleaning module 200 in order to guide an upper airflow.

The upper discharge grille 210 may include an inner wall 211 and an outer wall 212, which have a cylindrical shape. The plurality of grilles of the upper discharge grille 210 may interconnect the inner wall 211 and the outer wall 212 and may be disposed in a radial form.

The lower discharge grille 110 may include a plurality of grilles having a concentric circle structure. The plurality of grilles may be a plurality of circles having the same center and different radii. Each of the plurality of grilles may include a section bent in the radially outward direction. The lower discharge grille 110 may include a plurality of grilles bent at a predetermined angle in the outward direction. The lower discharge grille 110 may be disposed inside the discharge port 110a in order to deliver the lower discharge airflow in the lateral direction.

A bottom plate 170 is disposed below the first air cleaning module 100. The bottom plate 170 is disposed in contact with the floor to support the air cleaning modules 100 and 200.

An airflow guide 170a is disposed on the upper surface of the bottom plate 170 in order to guide air discharged downwardly through the first discharge port 110a in the lateral direction. The bottom plate 170 may further include a base 170b that supports the airflow guide 170a. The airflow guide 170a may be formed on the upper surface of the base 170b. In addition, the airflow guide 170a and the base 170b may be coupled to each other to constitute the bottom plate 170.

Air with foreign matter removed therefrom by the first filter 120 is discharged in the downward direction through the first discharge port 110a. Air with foreign matter removed therefrom by the second filter 220 is discharged in the upward direction through the second discharge port 210a. According to the present disclosure, although two air cleaning modules are stacked vertically, air is not discharged upwardly from the lower air cleaning module. Therefore, while suction performance is improved by forming the suction ports 11a and 12a in the peripheral surface of the case 10, it is possible to prevent air discharged from the lower air cleaning module from flowing back into the upper air cleaning module.

The 2-stage air cleaner of the related art has a problem in that purified air discharged from the lower air cleaning module flows upward and is suctioned into the upper air cleaning module, whereby air cleaning performance is reduced. In contrast, according to the present disclosure, purified air discharged from the lower air cleaning module flows downward, and thus introduction of the purified air into the upper air cleaning module is prevented, whereby air cleaning performance is improved.

Further, according to the present disclosure, since the air cleaner 1 does not need to have a structure for preventing introduction of purified air discharged therefrom or a configuration for discharge, the overall size of the product may be further reduced, and the freedom of design such as placement of internal parts may be improved.

For example, a control module 400 may be disposed at the center of the air cleaner 1, thereby reducing the lengths of power lines and signal lines, simplifying a line connection structure, and reducing the overall height of the product. Further, the control module 400 may be disposed between the air cleaning modules 100 and 200 so that the air cleaning modules 100 and 200 are controlled by the single integrated control module 400. Accordingly, each of the air cleaning modules 100 and 200 does not need to include an individual control module, and thus the overall height of the product may be reduced.

General allergen particles have a size of about 3 μm to about 100 μm, which is greater than the size of fine dust, and thus tend to settle on the floor. The lower airflow discharged downwardly from the first air cleaning module 100 causes allergen particles to float in the air and thus to be collected by the filters 120 and 220. In this way, it is possible to effectively remove allergens causing allergies using the lower airflow discharged downwardly from the first air cleaning module 100.

In addition, the air cleaner 1 may include UVC LEDs 481 and 482 (refer to FIG. 14), which are disposed in the case 10 and output ultraviolet in a wavelength band that has a sterilization effect on bacteria, mold, and microorganisms, and an ionizer, which is disposed in the case 10 and eliminates germs and mold using electricity supplied thereto.

In addition, the air cleaning modules 100 and 200 include fan housings 145 and 245 accommodating the blower fans 140 and 240 and a plurality of support parts 150 and 250 extending in the vertical direction from the fan housings 145 and 245. The plurality of support parts 150 and 250 may extend in the longitudinal direction of the air cleaner 1. The number of support parts 150 and 250 may be varied depending on the size or specifications of the product. Some of the support parts 150 and 250 may be different in at least one of shape, size, or material from the remaining ones of the support parts 150 and 250.

Each of wire covers 155 and 255 may be disposed on at least one surface of a respective one of the plurality of support parts 150 and 250 so as to cover a respective one of the support parts 150 and 250. The support parts 150 and 250 and the wire covers 155 and 255 may be spaced apart from each other to define spaces in which wires or the like are disposed.

In addition, the air cleaning modules 100 and 200 may further include wire covers 115 and 215, inside which wires or the like are disposed. The fan motors 130 and 230 may be accommodated in motor fastening parts 125 and 225, respectively.

The air cleaning modules 100 and 200 include filter mounting parts 160 and 260 in which the filters 120 and 220 are mounted, respectively. The control module 400 is disposed between the filter mounting parts 160 and 260.

Steel nets 165 and 265 are disposed between the filters 120 and 220 and the blower fans 140 and 240 in order to prevent body parts of the user or any other object from entering the spaces in which the blower fans 140 and 240 are disposed.

A top cover 270 is disposed on the top of the case 10. The upper discharge grille 210 is disposed inside the top cover 270.

In addition, a booster module 300 that regulates the direction of air discharged through the second discharge port 210a may be disposed above the air cleaning modules 100 and 200. The booster module 300 may be disposed above the second air cleaning module 200 in order to change the discharge direction of the airflow generated by the second air cleaning module 200.

The booster module 300 may send air discharged from the second air cleaning module 200 farther away. In addition, the booster module 300 may blend an airflow while rotating left and right, thereby forming various types of airflows. In some embodiments, the booster module 300 may move in the upward-downward direction so as to form a wider variety of airflows.

The booster module 300 may be removably mounted to the top of the second air cleaning module 200. In addition, a contact power supply structure may be applied to the booster module 300 and the second air cleaning module 200, so that power is supplied from the second air cleaning module 200 to the booster module 300 when the booster module 300 is mounted to the second air cleaning module 200.

When internal parts of the booster module 300, such as a booster fan 330, need to be washed, or when the upper discharge grille 210 disposed at the top of the second air cleaning module 200 needs to be cleaned, the booster module 300 may be removed. In this way, it is possible to conveniently keep the product hygienic.

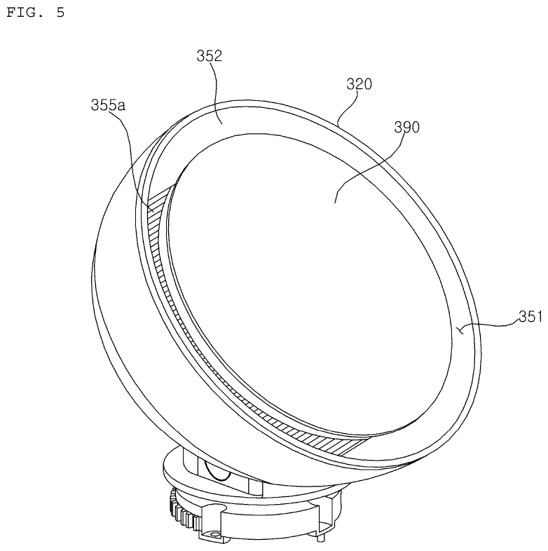

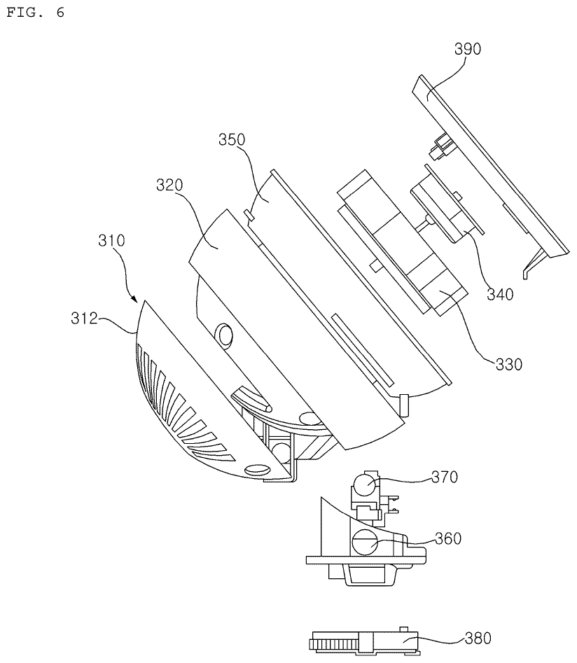

The booster module 300 includes an outer cover 320, an inner grille 355 disposed inside the outer cover 320 and having a discharge port 355a (refer to FIG. 5) formed therein, a rear suction grille 311 having a suction port 311a (refer to FIG. 6) formed therein, a booster fan 330 disposed on the front surface of the rear suction grille 311 and disposed inside the inner grille 355, and a motor 340 configured to rotate the booster fan 330.

The rear suction grille 311 may be a part of a rear cover 310 that forms the external appearance of the rear surface of the booster module 300. Alternatively, the rear suction grille 311 may be provided separately and coupled to the rear cover 310.

The rear cover 310 may have an opening formed therein so as to allow a portion of the upper end of a booster neck 360 to pass therethrough. In addition, the rear cover 310 may be coupled to the booster neck 360 by means of predetermined fastening member.

The booster module 300 may be supported by the booster neck 360 and may be mounted to the second air cleaning module 200.

The booster module 300 may be provided so as to be movable. The booster module 300 may be maintained in an inclined state or a lying state, as shown in FIG. 1.

The booster module 300 further includes a display panel 390 disposed on the front surface of the booster fan 330. The display panel 390 may cover the entirety of the front surface of the booster fan 330. The motor 340 may be disposed inside the booster fan 330.

The booster fan 330 may be a sirocco fan. If the booster fan 330 is implemented as a mixed-flow fan, an airflow is discharged through the front grille. However, the sirocco fan may discharge an airflow through the inner grille 355 formed laterally. Accordingly, it is possible to place the display panel 390 on the front surface of the fan, thereby shielding the fan structure. In addition, the sirocco fan has an advantage of reducing noise compared to the mixed-flow fan.

In addition, the booster module 300 further includes an inner flow guide 350 disposed between the outer cover 320 and the inner grille 355 in order to change the flow direction of air discharged through the discharge port 355a of the inner grille 355.

A slit 351 is formed between the inner flow guide 350 and the display panel 390. The air discharged through the discharge port 355a of the inner grille 355 passes through the slit 351, and then is discharged from the booster module 300.

FIG. 5 is an assembled view of the booster module according to the embodiment of the present disclosure, and FIGS. 6 and 7 are exploded views of the booster module according to the embodiment of the present disclosure.

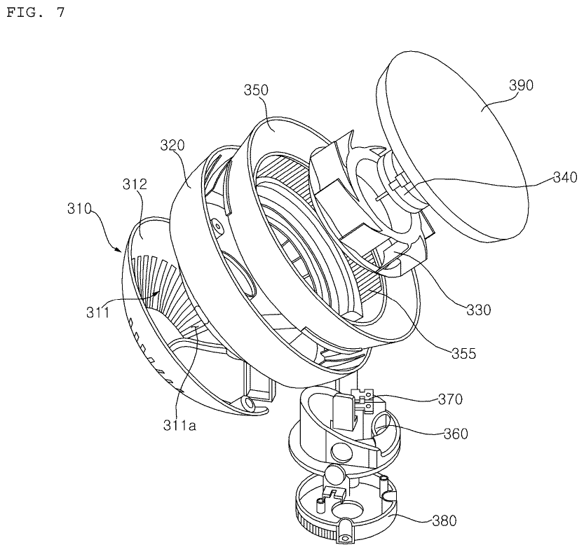

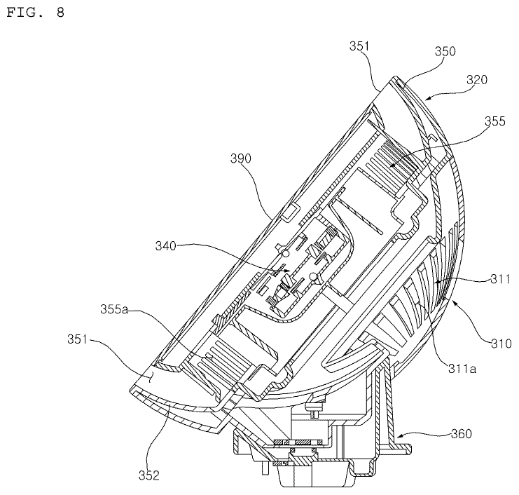

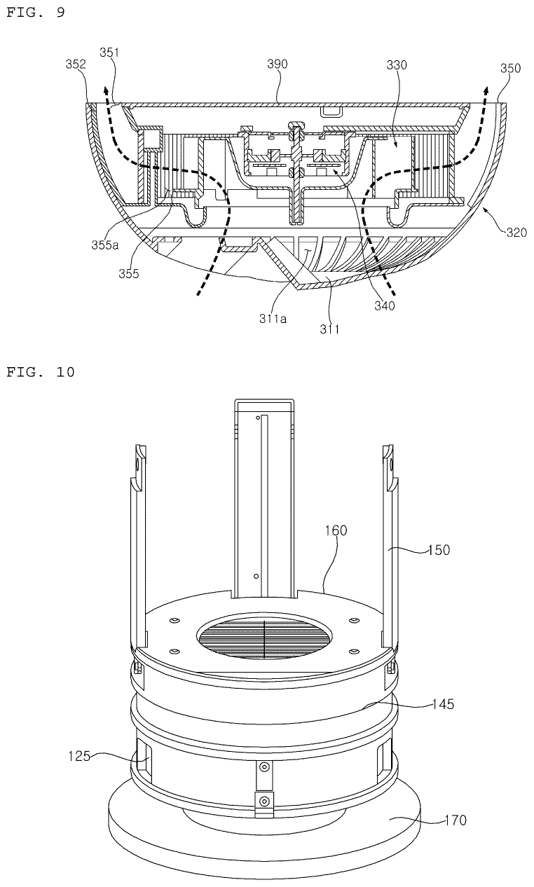

FIG. 8 is a cross-sectional view of the booster module according to the embodiment of the present disclosure, and FIG. 9 is a view showing an airflow in the booster module according to the embodiment of the present disclosure.

Referring to FIGS. 5 to 9, the display panel 390 that displays information about operation of the air cleaner 1 is disposed at the front of the booster module 300. The display panel 390 may move together with the booster module 300. The user may more easily view the information displayed on the display panel 390 disposed at the top of the product.

The booster fan 330 and the booster motor 340 are disposed on the rear surface of the display panel 390. The booster motor 340 is disposed inside the booster fan 330. The display panel 390 covers the entireties of the front surfaces of the booster fan 330 and the booster motor 340, thereby preventing exposure of the booster fan 330 to the user.

More preferably, the booster fan 330 may be a sirocco fan. If the booster fan 330 is implemented as a mixed-flow fan, air flows forward. Thus, the mixed-flow fan is not suitable for the slit-type flow path, and a front grille is required. However, if the booster fan 330 is implemented as a sirocco fan, resistance to an airflow discharged through the slit structure is reduced. Thus, the sirocco fan is suitable for the slit structure, and a front grille is eliminated. Accordingly, the fan and the inner grille are not visible from the outside.

The rear cover 310 and the outer cover 320 are coupled to each other to define a space in which parts are accommodated. The booster fan 330 and the booster motor 340 may be disposed in the inner space of the outer cover 320.

The inner grille 355 in which the discharge port 355a is formed and the inner flow guide 350 that changes the flow direction of air discharged through the discharge port 355a of the inner grille 355 are disposed between the outer cover 320 and the booster fan 330.

The inner grille 355 is disposed on the lateral side of the booster fan 330. The airflow caused by rotation of the booster fan 330 occurs along the discharge port 355a of the inner grille 355 formed laterally and the inner flow guide 350.

An inner flow path 352 including a forwardly curved surface is disposed on the inner surface of the inner flow guide 350. An end portion of the inner flow guide 350 and an end portion of the display panel 390 may be spaced a predetermined interval from each other to form the slit 351.

The air discharged through the discharge port 355a of the inner grille 355 passes through the inner flow path 352 and the slit 351, and then is discharged from the booster module 300.

According to the present disclosure, because an airflow is discharged through the slit 351, it is possible to minimize accumulation of dust on the booster fan 330 and the grille 355. Further, because the fan 330 and the grille 355 are not visible from the outside, the aesthetics of the product may be improved.

According to the present disclosure, an airflow is delivered through the inner grille 355 disposed on the lateral side of the booster fan 330, the inner flow path 352, and the slit 351, the blades of the booster fan 330 are not visible from the outside, and the size of the motor 340 is reduced. Further, according to the present disclosure, because a front grille is eliminated, it is possible to solve a problem of dust accumulating on a front grille.

The rear cover 310 includes a coupling portion 312 coupled to the outer cover 320 and a grille portion 311 in which the suction port 311a is formed. The grille portion 311 may include a plurality of grilles, and may be the aforementioned rear suction grille 311. The rear surface of the outer cover 320 may be formed corresponding to the shape of the coupling portion 312 and the coupling structure. For example, a stepped portion may be formed at the rear side of the outer cover 320, and a coupling member formed to be coupled to the coupling portion 312 may be disposed on the stepped portion so that the contours of the rear cover 310 and the outer cover 320 are smoothly connected when the rear cover 310 and the outer cover 320 are coupled to each other. The outer cover 320 may be coupled to the inner flow guide 350 using a coupling member formed on the inner surface thereof.

An assembly of components from the display panel 390 disposed at the front side to the rear suction grille 311 disposed at the rear side, which are disposed at the top of the air cleaner 1, may be referred to as a “booster head”.

The booster module 300 (or the booster head) is coupled to and supported by the booster neck 360. The booster neck 360 is coupled to the air cleaning modules 100 and 200, which correspond to the main body of the air cleaner 1.

The booster neck 360 may be coupled to the top of the second air cleaning module 200. Accordingly, at least a portion of the purified air discharged through the second discharge port 210a formed in the top of the second air cleaning module 200 may flow into the suction portion 311a of the rear suction grille 311.

The upper portion of the booster neck 360 may be coupled to the booster module 300. The lower portion of the booster neck 360 may be connected to the second air cleaning module 200. In order to further facilitate connection between the booster neck 360 and the second air cleaning module 200, a protruding portion may be formed at the lower portion of the booster neck 360 so as to protrude downward.

A head rotating part 380 may be located below the booster neck 360. The head rotating part 380 may be located inside the inner wall 211 of the upper discharge grille 210. The head rotating part 380 may include a structure for rotating the booster module 300 and a case for accommodating internal components, and may be connected to or accommodate components such as a stepper motor, an ionizer, and wires.

The upper end of the head rotating part 380 may be coupled to the booster neck 360. The lower end of the head rotating part 380 may be coupled to another mechanical structure of the second air cleaning module 200. For example, the lower end of the head rotating part 380 may be coupled to an upper side of the second fan housing 245.

Alternatively, the lower end of the head rotating part 380 may be coupled to an upper side of the second motor fastening part 225. In another embodiment, a separate coupling part (not shown) may be provided between the lower end of the head rotating part 380 and the upper end of the second fan housing 245 or the second motor fastening part 225.

The booster module 300 includes a power module 370. The power module 370 may include a power line for supply of power, a signal line for transmission of signals, and a terminal connected to the power line and the signal line.

When the booster module 300 is mounted to the second air cleaning module 200, the terminal of the power module 370 may come into contact with the terminal of the second air cleaning module 200, and accordingly, the power module 370 may receive power from the second air cleaning module 200.

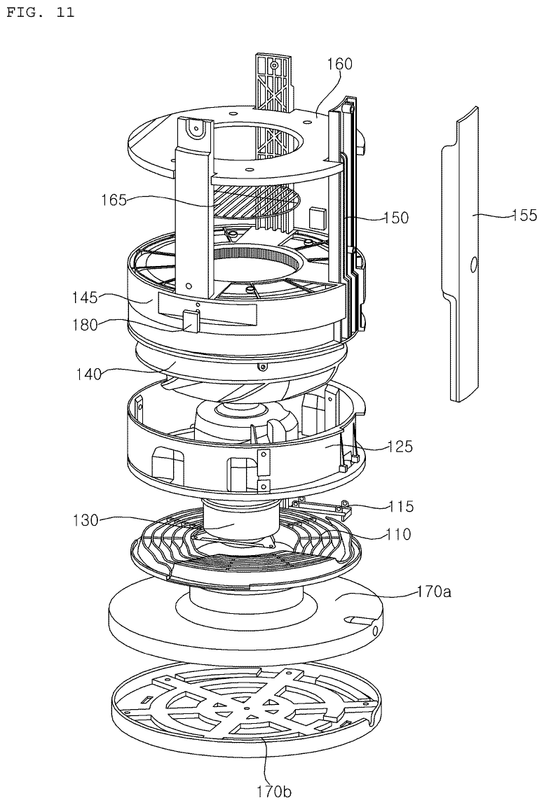

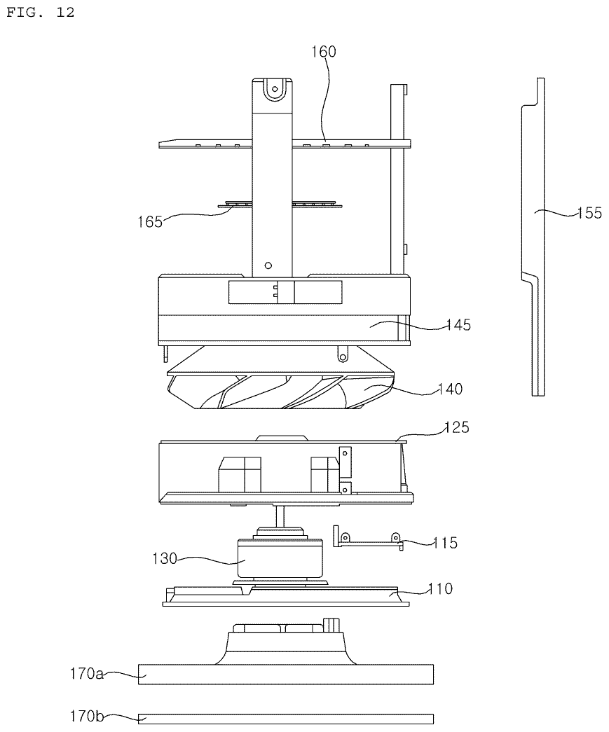

FIG. 10 is an assembled view of the first air cleaning module according to the embodiment of the present disclosure, and FIGS. 11 and 12 are exploded views of the first air cleaning module according to the embodiment of the present disclosure.

Referring to FIGS. 10 to 12, the first discharge port 110a that is open downward is formed in a lower portion of the first air cleaning module 100. The lower discharge grille 110 that changes the direction of air flowing downward is disposed inside the first discharge port 110a.

The annular first discharge port 110a is formed in a lower portion of the first air cleaning module 100. Air with foreign matter removed therefrom by the first filter 120 is discharged in the downward direction through the first discharge port 110a.

The lower discharge grille 110 may include a plurality of grilles bent at a predetermined angle in the outward direction. The lower discharge grille 110 may be disposed inside the first discharge port 110a in order to deliver the lower discharge airflow in the lateral direction.

The first air cleaning module 100 includes a first filter mounting part 160 to which the first filter 120 is mounted. The first filter 120 may be removably mounted to the first filter mounting part 160. The first filter 120 may have a hollow cylindrical shape, and air may be introduced through the outer circumferential surface of the first filter 120. While the air passes through the first filter 120, impurities such as fine dust may be removed from the air.

Because the first filter 120 has a cylindrical shape, air is capable of being introduced into the first filter 120 from any direction. Therefore, the air filtering area may increase.

The first filter mounting part 160 may be formed in a cylindrical shape corresponding to the shape of the first filter 120. In the process of mounting the first filter 120, the first filter 120 may be slidably fitted into the first filter mounting part 160. Conversely, in the process of demounting the first filter 120, the first filter 120 may be slidably withdrawn from the first filter mounting part 160.

The first air cleaning module 100 includes a first fan housing 145 disposed below the first filter 120, a first blower fan 140 rotatably disposed in the first fan housing 145, and a first fan motor 130 configured to rotate the first blower fan 140. In addition, the first air cleaning module 100 may further include a wire cover 115 that protects a wire connected to the first fan motor 130.

The first blower fan 140 suctions air in the axial direction and discharges the air downwardly in the radial direction. The first fan housing 145 may form a fan path that accommodates the first blower fan 140 and guides the air moved by the first blower fan 140 downwardly.

The first fan motor 130 may be supported by the first motor fastening part 125. The rotation shaft of the first fan motor 130 may extend upward from the first fan motor 130 and may pass through the bottom of the first motor fastening part 125 to be connected to the first blower fan 140.

First magnets 180 are disposed on two opposite sides of the first fan housing 145. The first magnets 180 may be coupled to metallic pieces of the first case 11. In addition, the first magnets 180 may be coupled to metallic pieces of the second case 12.

In some embodiments, each of the first magnets 180 may include a plurality of magnets. Some of the plurality of magnets may be coupled to the metallic pieces of the first case 11, and the remaining ones of the plurality of magnets may be coupled to the metallic pieces of the second case 12.

The positions of the magnets and the metallic pieces may be set to be opposite those exemplified above. For example, the metallic pieces may be disposed on two opposite sides of the first fan housing 145, and the magnets may be disposed at the first case 11 and the second case 12.

A plurality of support portions 150 extends upward from the first fan housing 145. For example, the support portions 150 may be beams elongated in the longitudinal direction. A wire cover 155 may be disposed on at least one surface of each of the plurality of support portions 150 so as to cover the support portions 150. The support portions 150 and the wire cover 155 may be spaced a predetermined interval from each other to define a space in which wires or the like are disposed.

A steel net 165 is disposed between the first filter 120 and the first blower fan 140 in order to prevent body parts of the user or any other object from entering the space in which the first blower fan 140 is disposed.

The bottom plate 170 is disposed below the first air cleaning module 100. The bottom plate 170 is disposed in contact with the floor to support the air cleaning modules 100 and 200.

The airflow guide 170a is disposed on the upper surface of the bottom plate 170 in order to guide air discharged downwardly through the first discharge port 110a in the lateral direction. The bottom plate 170 may further include a base 170b that supports the airflow guide 170a.

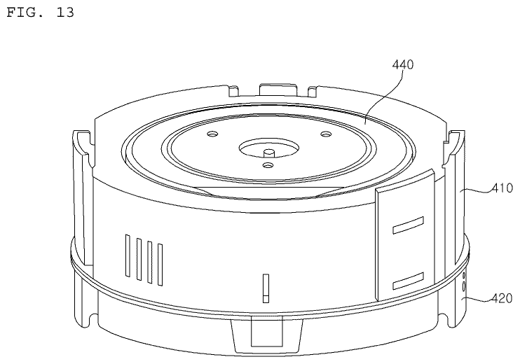

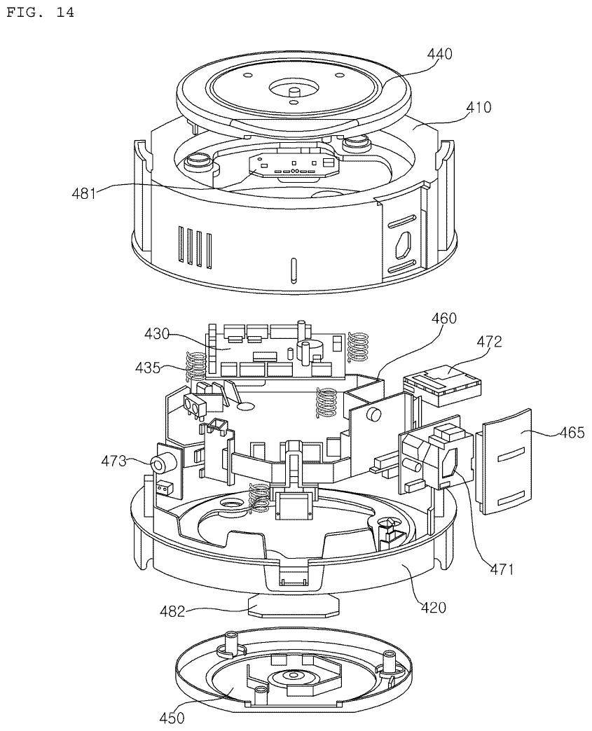

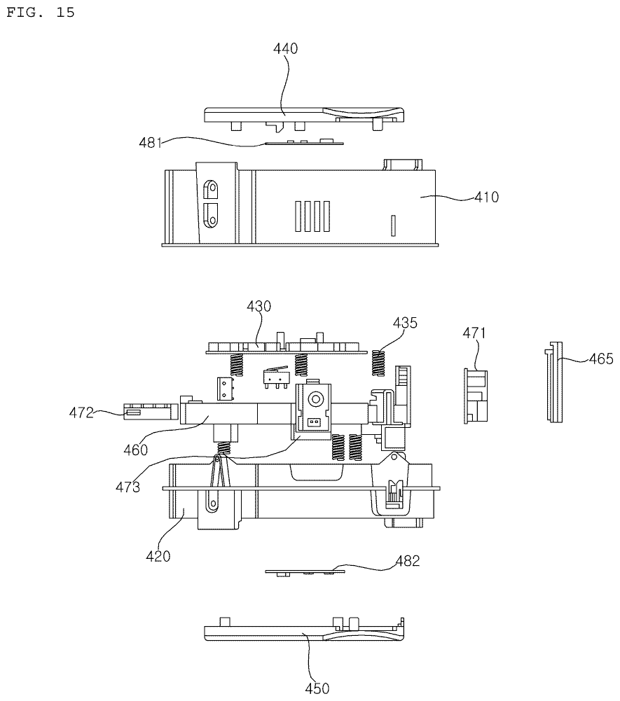

FIG. 13 is an assembled view of the control module according to the embodiment of the present disclosure, and FIGS. 14 and 15 are exploded views of the control module according to the embodiment of the present disclosure.

Referring to FIGS. 13 to 15, the control module 400 includes an upper cover 410 and a lower cover 420 that are coupled to each other to form the external appearance of the control module 400. The control module 400 includes a main PCB 430 on which circuits, such as a controller for control of overall operation of the air cleaner 1, are mounted, and the main PCB 430 is accommodated in an inner space defined by the upper cover 410 and the lower cover 420.

Each of the upper cover 410 and the lower cover 420 has a central cavity formed therein, and an upper filter pressing plate 440 and a lower filter pressing plate 450 are disposed in the central cavity of the upper cover 410 and the central cavity of the lower cover 420, respectively. Each of the upper filter pressing plate 440 and the lower filter pressing plate 450 may be connected to a plurality of springs 435.

The control module 400 may be located between the first air cleaning module 100 and the second air cleaning module 200. The control module 400 may be located above the first air cleaning module 100 and below the second air cleaning module 200.

Because the control module 400 is disposed between the first air cleaning module 100 and the second air cleaning module 200, the lengths of wires connecting the control module 400 to the first and second air cleaning modules 100 and 200 and variation in the lengths of the wires may be minimized, and the wiring structure may be simplified.

Further, because the filter pressing plates 440 and 450 are integrated with the upper and lower covers 410 and 420, vibration and noise may be further reduced, and manufacturing costs may be reduced.

When the first filter 120 is mounted to the first filter mounting part 160 of the first air cleaning module 100, the first filter 120 presses the lower filter pressing plate 450. When the second filter 220 is mounted to the second filter mounting part 260 of the second air cleaning module 200, the second filter 220 presses the upper filter pressing plate 440. Accordingly, the filters 120 and 220 may be more securely supported.

In addition, the control module 400 includes an upper UVC LED 481 and a lower UVC LED 482. The upper UVC LED 481 outputs UVC light upwardly toward the second air cleaning module 200 and the second filter 220. The lower UVC LED 482 outputs UVC light downwardly toward the first air cleaning module 100 and the first filter 120.

In general, ultraviolet light may be subdivided according to wavelength. For example, ultraviolet light may be classified into UVA having a wavelength of 320 nm to 400 nm, UVB having a wavelength of 280 nm to 320 nm, and UVC having a wavelength of 200 nm to 280 nm. In particular, UVC, which is short-wavelength ultraviolet light, has characteristics of destroying DNA of bacteria and causing a chemical reaction with a specific substance, and thus is effective for sterilization.

The control module 400 includes a mounting part 460 that supports the main PCB 430. Various sensors, such as an LED sensor 471, a laser sensor 472, and a gas sensor 473, may be mounted to the mounting part 460. Some of the sensors (e.g., the LED sensor 471) may include a cover 465.

The LED sensor 471 may emit infrared LED light and may detect light scattered by dust, thereby sensing the amount of dust. The laser sensor 472 may sense the amount of dust using laser light. The gas sensor 473 may sense the amount of gas in the air.

Although the LED sensor 471, the laser sensor 472, and the gas sensor 473 are illustrated in FIGS. 14 and 15, the disclosure is not limited thereto. The types of sensors provided and combinations thereof may be varied. In addition, one or more communication modules (not shown), such as a Wi-Fi module, may be provided inside the control module 400.

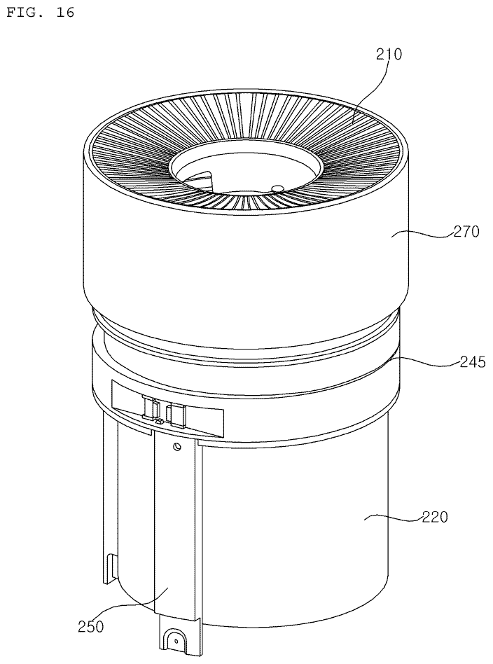

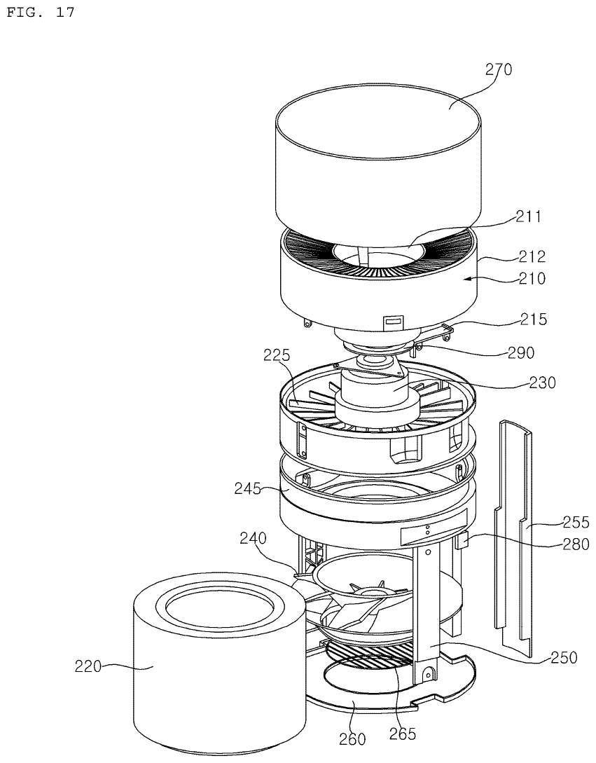

FIG. 16 is an assembled view of the second air cleaning module according to the embodiment of the present disclosure, and FIGS. 17 and 18 are exploded views of the second air cleaning module according to the embodiment of the present disclosure.

Referring to FIGS. 16 to 18, the second discharge port 210a that is open upward is formed in an upper portion of the second air cleaning module 200. The upper discharge grille 210 that changes the direction of air flowing upward is disposed inside the second discharge port 210a.

For example, the second discharge port 210a may be formed in a ring shape. The upper discharge grille 210 may be formed in a radial shape. The hollow top cover 270 is disposed so as to surround the upper discharge grille 210. The booster module 300 may be coupled to the center of the upper discharge grille 210. The head rotating part 380 may be disposed in the central cavity of the upper discharge grille 210 and may be coupled to the booster neck 360 supporting the booster module 300.

Air with foreign matter removed therefrom by the second filter 220 is discharged upwardly through the second discharge port 210a.

In the second air cleaning module 200, the second filter 220 is mounted to the second filter mounting part 260. The above description of the first filter 120 and the first filter mounting part 160 may be similarly applied to the second filter 220 and the second filter mounting part 260. However, while the first filter 120 and the first filter mounting part 160 are located above the first blower fan 140 and the first fan housing 145, the second filter 220 and the second filter mounting part 260 are located below the second blower fan 240 and the second fan housing 245.

The second air cleaning module 200 includes a second fan housing 245 disposed above the second filter 220, a second blower fan 240 rotatably disposed in the second fan housing 245, and a second fan motor 230 configured to rotate the second blower fan 240.

In addition, the second air cleaning module 200 may further include a wire cover 215 that protects a wire connected to the second fan motor 230. The second air cleaning module 200 may further include a rotary bearing 290 that reduces frictional force generated during rotation.

The second blower fan 240 suctions air in the axial direction and discharges the air upwardly in the radial direction. The second fan housing 245 may form a fan path that accommodates the second blower fan 240 and guides the air moved by the second blower fan 240 upwardly.

The second fan motor 230 may be supported by the second motor fastening part 225. The rotation shaft of the second fan motor 230 may extend downward from the second fan motor 230 and may pass through the top of the second motor fastening part 225 to be connected to the second blower fan 240.

Second magnets 280 are disposed on two opposite sides of the second fan housing 245. The second magnets 280 may be coupled to metallic pieces of the first case 11. In addition, the second magnets 280 may be coupled to metallic pieces of the second case 12.

In some embodiments, each of the second magnets 280 may include a plurality of magnets. Some of the plurality of magnets may be coupled to the metallic pieces of the first case 11, and the remaining ones of the plurality of magnets may be coupled to the metallic pieces of the second case 12. The positions of the magnets and the metallic pieces may be set to be opposite those exemplified above. For example, the metallic pieces may be disposed on two opposite sides of the second fan housing 245, and the magnets may be disposed at the first case 11 and the second case 12.

A plurality of support portions 250 extends downward from the second fan housing 245. For example, the support portions 250 may be beams elongated in the longitudinal direction. A wire cover 255 may be disposed on at least one surface of each of the plurality of support portions 250 so as to cover the support portions 250. The support portions 250 and the wire cover 255 may be spaced a predetermined interval from each other to define a space in which wires or the like are disposed.

A steel net 265 is disposed between the second filter 220 and the second blower fan 240 in order to prevent body parts of the user or any other object from entering the space in which the second blower fan 240 is disposed.

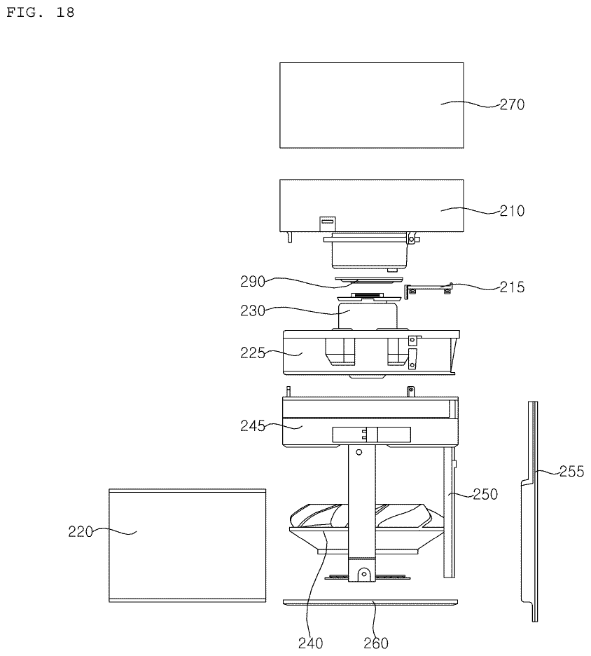

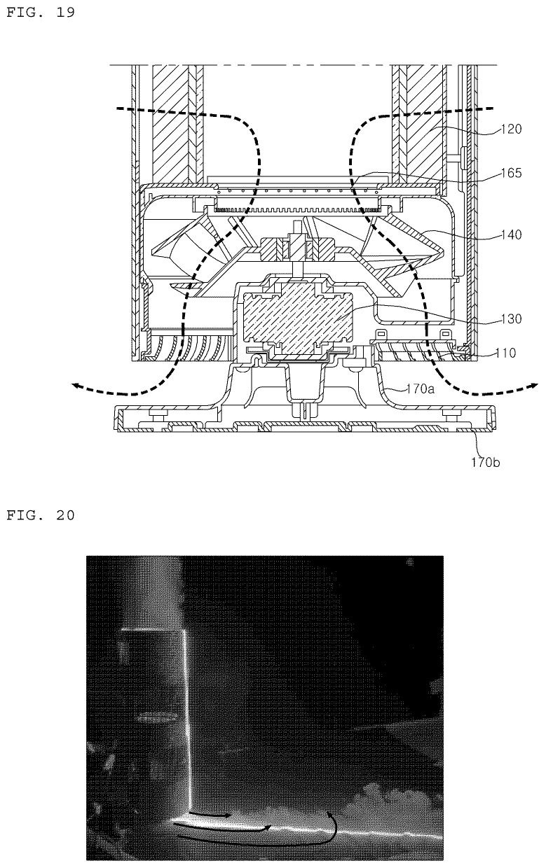

FIGS. 19 to 21 are views for explaining discharge of purified air through the bottom of the air cleaner according to the embodiment of the present disclosure.

FIG. 19 is a view showing the flow path of the lower discharge airflow, and FIG. 20 is a view visualizing the lower discharge airflow using a laser. FIG. 21 is an enlarged view of a lower discharge airflow guide structure.

Referring to FIGS. 19 to 21, the first discharge port 110a is formed in the lower end of the first air cleaning module 100, and the lower discharge grille 110 is disposed inside the first discharge port 110a in order to guide the lower discharge airflow.

The lower discharge grille 110 may include a plurality of grilles bent at a predetermined angle in the outward direction. The lower discharge grille 110 may be disposed inside the first discharge port 110a in order to deliver the lower discharge airflow in the lateral direction.

When the first blower fan 140 is rotated by the first motor 130, the air purified by the first filter 120 is discharged through the first discharge port 110a as the lower discharge airflow.

The airflow guide 170a is disposed on the upper surface of the bottom plate 170 in order to guide air discharged downwardly through the first discharge port 110a in the lateral direction.

General allergen particles, which have a size of about 3 μm to about 100 μm, are larger and heavier than indoor floating dust particles, which have a size of about 1 μm, and thus tend to settle on the floor. For example, mold particles have a size of about 10 μm, household dust allergen particles have a size of about 15 μm, and pollen particles have a size of about 50 μm.

Because virus or cigarette smoke particles have a very small size, the same tend to continuously float without settling on the floor. Indoor floating dust particles remain suspended in the air for a very long time. For example, it takes about 9 to 10 hours for indoor floating dust particles to settle from the ceiling to the floor of the room.

However, under the same conditions, mold particles, household dust allergen particles, and pollen particles float for a short time of several seconds to several minutes and then settle on the floor. Therefore, it is not easy for the conventional air cleaner to capture allergen particles. Conventionally, the only way to remove the settled particles is to use a vacuum cleaner.

According to the present disclosure, the lower airflow discharged downwardly from the first air cleaning module 100 may cause allergen particles to float in the air, and the floating allergen particles may be captured by the filters 120 and 220.

Meanwhile, according to an embodiment of the present disclosure, the speed of the lower discharge airflow may be controlled in response to the terminal velocity of allergen particles. The speed of the lower discharge airflow may be set to be higher than the terminal velocity of allergen particles.

The rotational speed of the first blower fan 140 may be controlled based on the terminal velocity of allergen particles. The rotational speed of the first blower fan 140 may correspond to the speed of the lower discharge airflow set to be higher than the terminal velocity of allergen particles. The controller mounted on the main PCB 430 of the control module 400 may control the rotational speed of the first blower fan 140.

The terminal velocity of allergen particles may be calculated using balance between gravity, buoyancy, and drag force acting on allergen particles. For example, the terminal velocity of allergen particles may be calculated using Stokes' terminal velocity formula.

In order to cause mold particles having a size of about 10 μm and household dust allergen particles having a size of about 15 μm to float in the air, the speed of the lower discharge airflow may be set to be higher than the terminal velocity of larger household dust allergen particles. For example, the speed of the lower discharge airflow may be set to 0.0038 m/s or higher.

The airflow guide 170a includes a curved portion 173, a flat portion 171 extending laterally from the curved portion 173, and a boss 172 protruding upward from an end portion of the flat portion 171.

The boss 172 may form an airflow that effectively causes allergen particles to float in the air. The boss 172 may reduce flow resistance at the end portion of the flat portion 171.

The boss 172 may prevent flow separation at the end portion of the flat portion 171. The boss 172 may be formed in a ring shape along the edge of the airflow guide 170a. The boss 172 may protrude from the flat portion 171 by a predetermined height d1, thereby preventing the occurrence of turbulence at the end portion of the flat portion 171 and causing the airflow to ascend. Accordingly, it is possible to effectively cause allergen particles settled on the floor to float in the air while preventing flow separation.

If the height d1 of the boss 172 is too great, it may excessively increase the degree of ascending of the airflow, which is inappropriate for causing allergen particles settled on the floor to float in the air. Therefore, it is desirable that the height d1 of the boss 172 be set to several millimeters (mm) or less, so long as the boss 172 is capable of preventing flow separation.

The curved portion 173 may be formed so as to surround the central pillar 175 of the bottom plate 170. The curved portion 173, which imparts a curvature to the airflow guide 170a, may be formed so as to be round with a predetermined radius of curvature R1. The radius of curvature R1 may be set so as to guide the lower discharge airflow to smoothly flow in the lateral direction.

The grille bending angle of the lower discharge grille 110 may be set to 20 degrees to 40 degrees so that the airflow rises at 20 degrees or greater in order to cause allergen particles on the floor to float in the air.

The radius of curvature R1 may be set corresponding to the grille bending angle of the lower discharge grille 110. For example, a predetermined angle ag1 based on the vertical direction may be determined corresponding to the grille bending angle of the lower discharge grille 110, and the radius of curvature R1 may be set so as to implement the determined angle ag1. In more detail, the angle ag1 may be set to be smaller than the grille bending angle of the lower discharge grille 110.

The predetermined angle ag1 may be an angle between the central pillar 175 and the curved portion 173. In this case, the predetermined angle ag1 may be smaller than the angle of the discharge airflow through the discharge port 110. The angle of the discharge airflow may correspond to the grille arrangement angle and grille bending angle of the lower discharge grille 110.

The curved portion 173 may guide the lower discharge airflow to smoothly flow in the lateral direction, thereby reducing flow resistance. According to the present disclosure, in order to deliver the lower discharge airflow in the lateral direction, the bottom plate 170 is imparted with a curvature, and the boss 172 is formed at an end portion of the flat portion 171. Accordingly, a turbulent flow for causing allergen particles to float in the air may be created. That is, because the airflow guide 170a is imparted with an inclination and a curvature and is provided with the boss for preventing flow separation, resistance to the lower discharge airflow may be minimized.

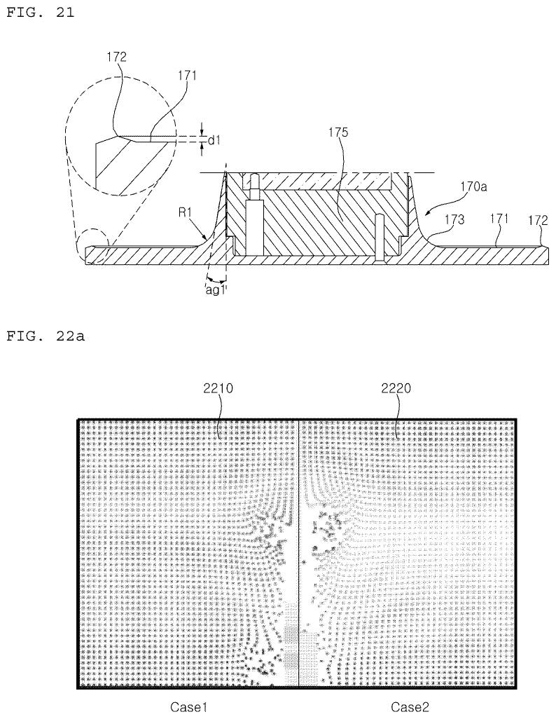

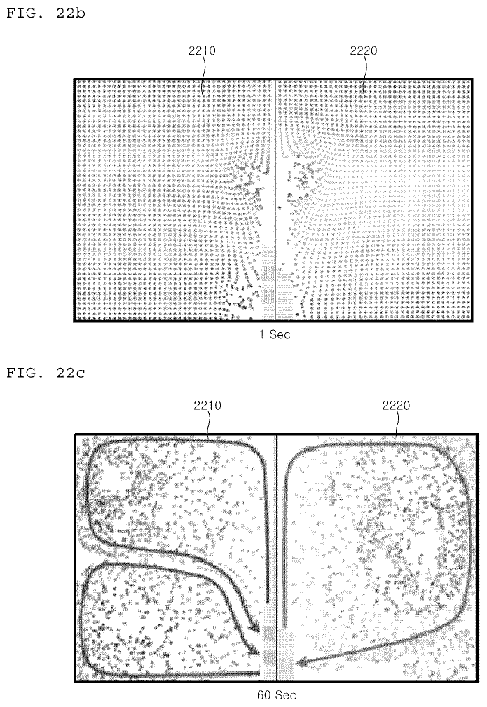

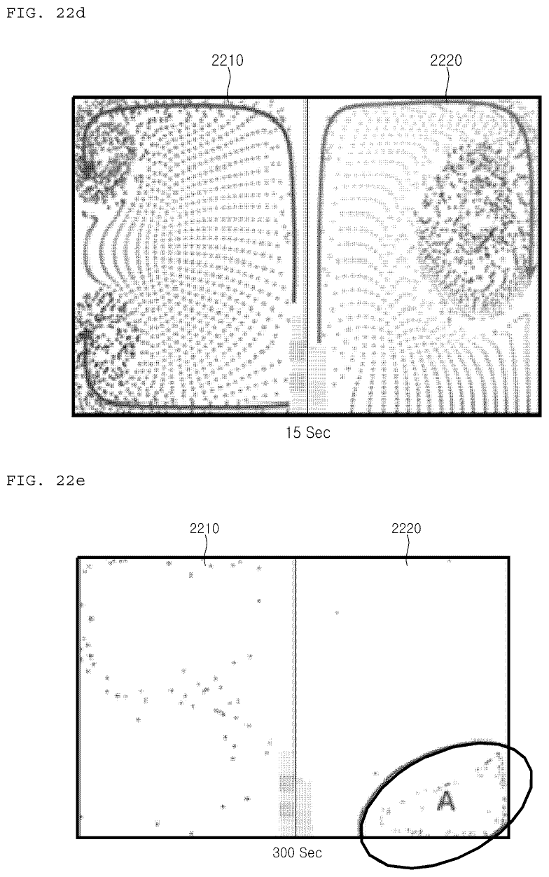

FIGS. 22A to 22E are views for explaining performance comparison between a case in which purified air is discharged through the upper and lower ends of the product and a case in which purified air is discharged only through the upper end of the product.

In FIGS. 22A to 22E, Case 1 corresponds to a case in which purified air is discharged through the upper and lower ends of the product, and the allergen removal performance over time of Case 1 is shown in the left region 2210. In FIGS. 22A to 22E, Case 2 corresponds to a case in which purified air is discharged only through the upper end of the product, and the allergen removal performance over time of Case 2 is shown in the right region 2220.

FIG. 22A shows the initial state, FIG. 22B shows the state after the elapse of 1 second, FIG. 22C shows the state after the elapse of 15 seconds, FIG. 22D shows the state after the elapse of 60 seconds, and FIG. 22E shows the state after the elapse of 300 seconds.

Referring to FIGS. 22A to 22E, it can be seen that a flow stagnant zone A occurs on the floor after the elapse of a short floating time of allergen particles in the case in which purified air is discharged only through the upper end of the product.

In contrast, in the case in which purified air is discharged through the upper and lower ends of the product, since air smoothly circulates in the room, it is possible to more effectively remove allergen particles, which are greatly influenced by an airflow.

When the lower discharge airflow is applied, the performance of removing allergen particles of 2.8 μm or greater is greatly improved (by about 18% or greater), compared to improvement of the performance of removing fine dust (0.3 μm).

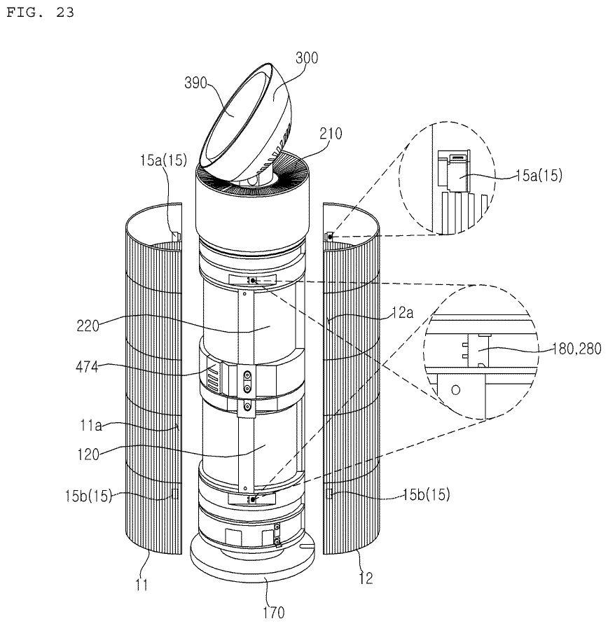

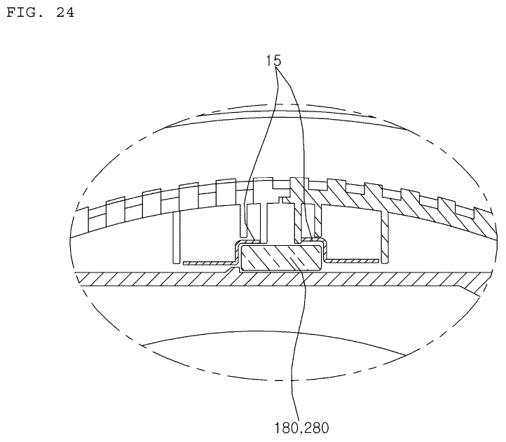

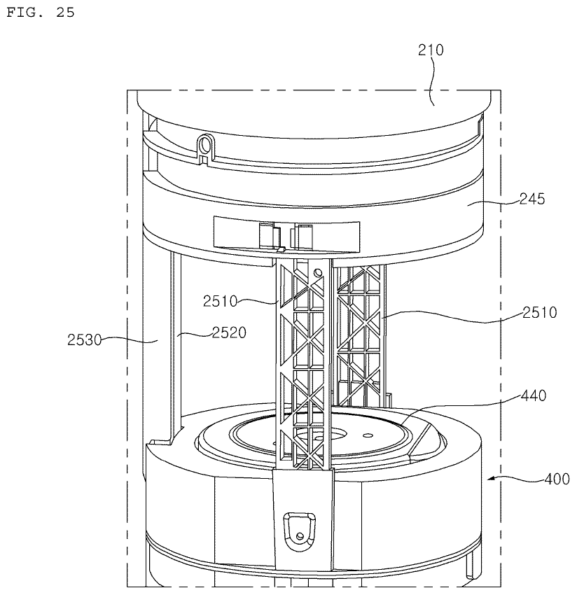

FIGS. 23 and 24 are views for explaining the case coupling structure according to the embodiment of the present disclosure. FIG. 23 shows the magnets and the metallic pieces in the state in which the case is separated therefrom, and FIG. 24 is a cross-sectional view showing the coupling state of the magnets and the metallic pieces when the case coupled thereto is viewed from above.

The air cleaning modules 100 and 200 include first magnets 180 and second magnets 280. The second magnets 280 are disposed above the first magnets 180. The first air cleaning module 100 may include the first magnets 180, and the second air cleaning module 200 may include the second magnets 280.

For example, the first magnets 180 may be disposed on two opposite sides of the first fan housing 145 of the first air cleaning module 100. In addition, the second magnets 280 may be disposed on two opposite sides of the second fan housing 245 of the second air cleaning module 200.

The first magnets 180 may be coupled to the metallic pieces 15 of the first case 11. In addition, the first magnets 180 may be coupled to the metallic pieces 15 of the second case 12.

The second magnets 280 may be coupled to the metallic pieces 15 of the first case 11. In addition, the second magnets 280 may be coupled to the metallic pieces 15 of the second case 12.

In some embodiments, each of the first magnets 180 may include a plurality of magnets. Some of the plurality of magnets may be coupled to the metallic pieces of the first case 11, and the remaining ones of the plurality of magnets may be coupled to the metallic pieces of the second case 12. The positions of the magnets and the metallic pieces may be set to be opposite those exemplified above. For example, the metallic pieces may be disposed on two opposite sides of the first fan housing 145, and the magnets may be disposed at the first case 11 and the second case 12.

The first case 11 may include lower metallic pieces 15b coupled to the first magnets 180 and upper metallic pieces 15a coupled to the second magnets 280.

Similarly, the second case 12 may also include lower metallic pieces 15b coupled to the first magnets 180 and upper metallic pieces 15a coupled to the second magnets 280.

The lower metallic pieces 15b of the first case 11 and the second case 12 are coupled to the first magnets 180. The upper metallic pieces 15a of the first case 11 and the second case 12 are coupled to the second magnets 280.

In the case of the conventional 2-stage air cleaner, each of the air cleaning modules requires individual cases. Therefore, demounting and mounting processes are complicated and time-consuming. For example, a total of eight coupling parts may be included in the cases, which increases the number of components (magnets and metallic pieces). Further, because the intermediate portion of the product appears discontinuous, the aesthetics of the product deteriorates.

In order to solve this problem, according to the present disclosure, the upper/lower outer grille is implemented in an integral form in each of the air cleaning modules, rather than being divided into two parts, whereby the aesthetics of the product is improved, the number of coupling components is reduced, and use convenience is improved. According to the present disclosure, each of the first case 11, which is the front case, and the second case 12, which is the rear case, is implemented in an integral form as a common cover for the air cleaning modules 100 and 200, whereby demounting and mounting processes may be simplified, and manufacturing costs may be reduced. Further, according to the present disclosure, it is possible to check the internal state of the product by separating only one of the first case 11 and the second case 12.

The control module 400 may be disposed between the first air cleaning module 100 and the second air cleaning module 200. The control module 400 may include a dust sensor 474. For example, the dust sensor 474 may include at least one of the LED sensor 471, the laser sensor 472, or the gas sensor 473 mentioned above.

According to the present disclosure, some of the support parts 150 and 250 may be formed in a truss structure in which a plurality of linear members is arranged in a plurality of triangular forms, thereby securing sufficient mechanical rigidity and increasing the suction area.

Hereinafter, the structure of the support parts will be described in detail with reference to the drawings.

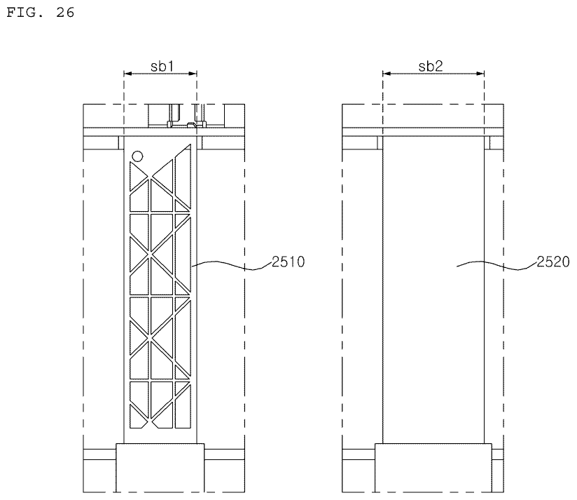

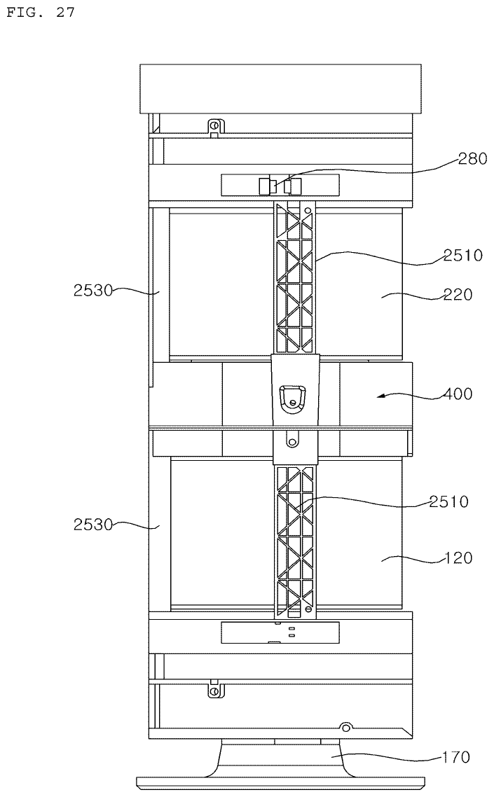

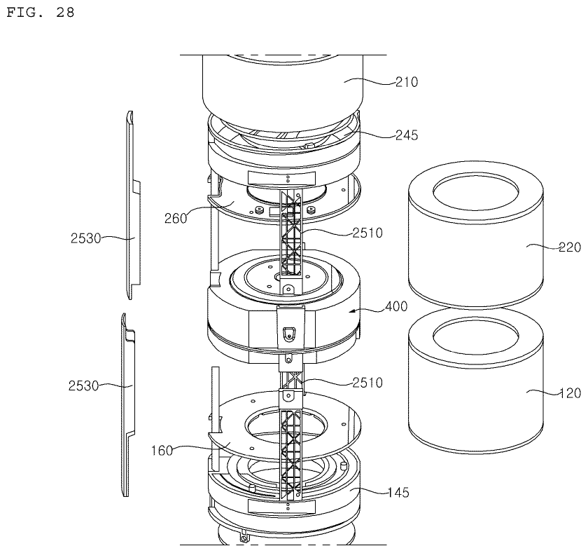

FIGS. 25 to 28 are views for explaining the structure of the support parts according to the embodiment of the present disclosure.

Referring to FIGS. 25 to 28, the air cleaning modules 100 and 200 include fan housings 145 and 245 and a plurality of first support parts 2510 extending from the fan housings 145 and 245 in the longitudinal direction.

One side of each of the first support parts 2510 may be connected to the fan housings 145 and 245, and the other side of each of the first support parts 2510 may be connected to the control module 400. Accordingly, the first support parts 2510 may support the filters 120 and 220 mounted to the filter mounting parts 160 and 260 from the lateral direction.

The first support parts 2510 are formed in a truss structure in which a plurality of linear members is arranged in a plurality of triangular forms. At least two first support parts 2510 may be disposed on the side surfaces of the filters 120 and 220 so as to face each other.

The air cleaning modules 100 and 200 may include one or more second support parts 2520 extending from the fan housings 145 and 245 in the longitudinal direction and a wire cover 2530 covering at least one surface of each of the second support parts 2520. The wire cover 2530 may be disposed so as to be spaced a predetermined interval from one side of each of the second support parts 2520.

In order to secure sufficient space for accommodating wires or the like, the width sb2 of the second support part 2520 may be larger than the width sb1 of the first support part 2510. Because at least one surface of the second support part 2520 is shielded by the wire cover 2530, the second support part 2520 may be implemented as a general beam column, rather than being formed in a truss structure.

Each of the first air cleaning module 100 and the second air cleaning module 200 may include the first support part 2510.

The first support part 2510 of the first air cleaning module 100 may extend upward from the first fan housing 145. The first support part 2510 of the second air cleaning module 200 may extend downward from the second fan housing 245.

If a general column structure is applied to the side surfaces of the filters 120 and 220, the suction areas of the filters 120 and 220 may decrease in inverse proportion to the area of the column, and the air cleaning performance may be reduced. However, according to the present disclosure, since the first support part 2510 is formed in a truss structure, additional suction areas may be secured in the side surfaces of the filters 120 and 220, and flow resistance caused by shielding of the column may be minimized.

As is apparent from the above description, according to at least one of the embodiments of the present disclosure, an air cleaner includes a first discharge port formed in the bottom thereof and a second discharge port formed in the top thereof, and air with foreign matter removed therefrom is discharged downwardly through the first discharge port formed in the bottom and is discharged upwardly through the second discharge port formed in the top. Accordingly, an air return phenomenon may be prevented.

According to at least one of the embodiments of the present disclosure, a first air cleaning module configured to discharge purified air through the bottom thereof is disposed at a lower position, and a second air cleaning module configured to discharge purified air through the top thereof is disposed at an upper position. Accordingly, it is possible to prevent air discharged from the first air cleaning module from being introduced into the second air cleaning module and to improve air cleaning performance.

According to at least one of the embodiments of the present disclosure, because a booster module including a fan is disposed on the top of the air cleaning module, it is possible to send purified air farther away.

According to at least one of the embodiments of the present disclosure, because an airflow guide is disposed on the upper surface of a bottom plate, which is disposed below the air cleaning module so as to be in contact with the floor, in order to guide air discharged downwardly through the first discharge port in the lateral direction, allergens causing allergies may be caused to float in the air and captured. Accordingly, it is possible to effectively remove allergens.

According to at least one of the embodiments of the present disclosure, because the airflow guide includes a boss protruding upward from an end portion thereof, it is possible to reduce flow resistance.

According to at least one of the embodiments of the present disclosure, because a lower discharge grille including a plurality of grilles bent in the outward direction is disposed inside the first discharge port, it is possible to create a lower discharge airflow for floating of allergen particles.

According to at least one of the embodiments of the present disclosure, because the booster module is configured such that a display panel is disposed so as to cover the entirety of the front surface of a booster fan and air is discharged through a slit formed beside the display panel, it is possible to prevent dust from accumulating on the booster fan and the inner grille.

According to at least one of the embodiments of the present disclosure, because the booster module is removably mounted on the top of the second air cleaning module, cleaning and maintenance of the product may be facilitated.

According to at least one of the embodiments of the present disclosure, because the booster module further includes a power module that comes into contact t with a terminal of the second air cleaning module when mounted and receives power from the second air cleaning module, demounting and mounting of the booster module may be further facilitated.

According to at least one of the embodiments of the present disclosure, because a case is commonly used to cover the outer circumferential surfaces of the air cleaning modules stacked vertically, rather than being divided into parts for the respective air cleaning modules, coupling and separation of the case may be facilitated, and manufacturing costs may be reduced.

According to at least one of the embodiments of the present disclosure, because the case is conveniently coupled and separated using a small number of magnets and metallic pieces, maintenance and repair of internal components may be facilitated.

According to at least one of the embodiments of the present disclosure, because some of a plurality of support parts extending vertically from the fan housing are formed in a truss structure, the air suction area of the filter may be increased.

The effects achievable through the disclosure are not limited to the above-mentioned effects, and other effects not mentioned herein will be clearly understood by those skilled in the art from the description of the claims.

Although the present disclosure has been described with reference to specific embodiments shown in the drawings, it is apparent to those skilled in the art that the present disclosure is not limited to those exemplary embodiments and is embodied in many forms without departing from the scope of the present disclosure, which is described in the following claims. These modifications should not be individually understood from the technical spirit or scope of the present disclosure.

What is claimed is:

1. An air cleaner comprising:
a case including a suction port disposed on a peripheral surface of the case;
a first air cleaning module disposed in the case, the first air cleaning module comprising a first blower fan, a first filter configured to remove foreign matter from air introduced through the suction port, and a first discharge port disposed at a bottom of the first air cleaning module, the first discharge port being configured to discharge air filtered by the first filter in a downward direction; and
a second air cleaning module disposed in the case, the second air cleaning module comprising a second blower fan, a second filter configured to remove foreign matter from air introduced through the suction port, and a second discharge port disposed at a top of the second air cleaning module, the second discharge port being configured to discharge air filtered by the second filter in an upward direction, and the second air cleaning module being disposed above the first air cleaning module.

2. The air cleaner according to claim 1, further comprising a bottom plate disposed below the first air cleaning module and configured to be in contact with a floor, the bottom plate comprising an airflow guide disposed on an upper surface of the bottom plate, the airflow guide being configured to guide air discharged downwardly through the first discharge port in a lateral direction.

3. The air cleaner according to claim 2, wherein the airflow guide comprises:
a curved portion;
a flat portion extending laterally from the curved portion; and
a boss protruding upward from an end portion of the flat portion.

4. The air cleaner according to claim 1, further comprising a lower discharge grille disposed inside the first discharge port, the lower discharge grille comprising a plurality of grilles bent in an outward direction.

5. The air cleaner according to claim 4, wherein the plurality of grilles are arranged in a concentric circle structure.

6. The air cleaner according to claim 1, further comprising a booster module disposed above the second air cleaning module, the booster module being configured to control a direction of air discharged through the second discharge port.

7. The air cleaner according to claim 6, wherein the booster module comprises:
an outer cover;
an inner grille disposed inside the outer cover, the inner grille comprising a discharge port;
a rear suction grille comprising a suction port;
a booster fan disposed at a front of the rear suction grille and disposed inside the inner grille; and
a motor configured to rotate the booster fan.

8. The air cleaner according to claim 7, wherein the booster module further comprises:
a display panel disposed at a front of the booster fan; and
an inner flow guide disposed between the outer cover and the inner grille, the inner flow guide being configured to change a flow direction of air discharged through the discharge port of the inner grille,
wherein the discharge port of the inner grille is configured to discharge air to pass through a slit disposed between the inner flow guide and the display panel.

9. The air cleaner according to claim 8, wherein the display panel covers an entire front surface of the booster fan.

10. The air cleaner according to claim 9, wherein the motor is disposed inside the booster fan.

11. An air cleaner comprising:
a case including a suction port disposed on a peripheral surface of the case;
an air cleaning module disposed in the case, the air cleaning module comprising:
a blower fan;
a filter configured to remove foreign matter from air introduced through the suction port;
a first discharge port disposed in a bottom of the air cleaning module, the first discharge port being configured to discharge air in a downward direction; and
a second discharge port disposed in a top of the air cleaning module, the second discharge port being configured to discharge air in an upward direction; and
a booster module disposed above the air cleaning module, the booster module being configured to receive at least a portion of the air discharged by the second discharge port.

12. The air cleaner according to claim 11, further comprising a bottom plate disposed below the air cleaning module and configured to be in contact with a floor, the bottom plate comprising an airflow guide disposed on an upper surface of the bottom plate, the air flow guide being configured to guide air discharged downwardly through the first discharge port in a lateral direction.

13. The air cleaner according to claim 12, wherein the airflow guide comprises:
a curved portion;
a flat portion extending laterally from the curved portion; and
a boss protruding upward from an end portion of the flat portion.

14. The air cleaner according to claim 11, further comprising a lower discharge grille disposed inside the first discharge port, the lower discharge grille comprising a plurality of grilles bent in an outward direction.

15. The air cleaner according to claim 14, wherein the plurality of grilles are arranged in a concentric circle structure.

16. The air cleaner according to claim 11, wherein the booster module comprises:
an outer cover;
an inner grille disposed inside the outer cover, the inner grille comprising a discharge port;
a rear suction grille comprising a suction port;
a booster fan disposed at a front of the rear suction grille and disposed inside the inner grille; and
a motor configured to rotate the booster fan.

17. The air cleaner according to claim 16, wherein the booster module further comprises:
a display panel disposed at a front of the booster fan; and
an inner flow guide disposed between the outer cover and the inner grille, the inner flow guide being configured to change a flow direction of air discharged through the discharge port of the inner grille,
wherein the air discharged through the discharge port of the inner grille is configured to pass through a slit formed between the inner flow guide and the display panel.

18. The air cleaner according to claim 17, wherein the display panel covers an entire front surface of the booster fan.

19. The air cleaner according to claim 16, wherein the motor is disposed inside the booster fan.

20. The air cleaner according to claim 11, wherein the booster module is removably mounted to the top of the air cleaning module, the booster module further comprising a power module configured to come into contact with a terminal of the air cleaning module and receive power from the air cleaning module.
